(19) United States
(12) Patent Application Publication
(10) Pub. No.: US 2022/0234875 A1
(43) Pub. Date: Jul. 28, 2022

(54) TIMBER JACK WITH ARCUATE FULCRUM

(71) Applicant: BAC Industries, Inc., Miltona, MN (US)

(72) Inventors: Robert H. Lusty, Alexandria, MN (US); James D. Oberg, Eagle Bend, MN (US)

(21) Appl. No.: 17/158,400

(22) Filed: Jan. 26, 2021

(51) Int. Cl. B66F 15/00; B27B 31/06

(52) U.S. Cl. CPC B66F 15/00; B27B 31/06

(57) ABSTRACT

An improved timber jack for raising and supporting logs off from the ground has an elongated lever arm handle member supporting a fulcrum at a distal end of the handle creating a lever of the first class. The novelty resides in having an arcuate fulcrum such that applying a force at a proximal end of the handle causes the fulcrum to roll on the ground as the log is being lifted. Less effort is required to lift a given load as compared to conventional timber jacks.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

### I. Field of the Invention

The present invention relates generally to logging tools and, more particularly, to logging jacks used to elevate downed logs from the ground to facilitate the cutting of logs into smaller lengths using a chain saw without worry that the chain saw blade member will engage the ground and become dull.

### II. Discussion of the Prior Art

Many forms of log jack devices are known in the art, one type of which is shown in FIG. 1 hereof. It is seen to comprise an elongate wooden cylindrical handle 2 that is fitted into a tubular steel collar 4 at a distal end thereof. A curved arm 6 is joined at one end by a clevis connection 8 and the arm 6 is terminated at an opposite end in a sharply pointed hook 10. Also rigidly connected to the steel collar 4 at its distal end is a perpendicularly extending leg 12 terminating in a transversely extending bar 14 that functions as a ground-engaging foot.

In use, the handle is raised so as to be generally perpendicular to the ground and with the collar 4 against a side surface of a log and with the arm 6 extending over a top surface of the log. At this time, the foot 14 will be elevated only slightly above the ground. Now, a user rotating the handle from the vertical toward the horizontal will cause the foot 14 to act as a lever fulcrum of a lever of the first class and the log, being held by the arcuate arm and a barb 18 also welded to the collar 4, will be elevated as determined by the length of the leg 12 and made to rest on the collar 4 when the proximal end 16 of the handle is made to rest on the ground. Depending on the weight of the log being lifted, this can require considerable effort by the user to lift the log even though levering action is involved.

The present invention involves a modification of the above-described prior art timber jack that significantly reduces the manual effort involved in elevating logs from the ground.

### SUMMARY OF THE INVENTION

In accordance with one embodiment of the present invention, there is provided an improved timber jack for elevating cut logs, such as tree trunks, from the ground to facilitate the cutting thereof into shorter lengths using a chain saw. It comprises at least one elongate handle member having proximal and distal ends and a curved arm having one end connected by a clevis at a position on the elongate handle that is a predetermined distance from the distal end and when the curved arm terminates at its free end in a log piercing member. Rather than having a leg and foot member, as in the above-described prior art, an arcuate fulcrum member is rigidly affixed at the distal end of the elongate handle member. As such, the effort needed to elevate a log is reduced due to a rolling action rather than a lifting action, as in the prior art.

In accordance with a further embodiment, the elongate handle member is U-shaped, defining first and second legs connected together at their proximal ends by a cross bar element and where each of the pair of legs has one of the curved arms connected by a clevis at a location that is a predetermined distance from the distal ends thereof and having one of the arcuate fulcrum members rigidly affixed at a distal end of each of the pair of legs.

### BRIEF DESCRIPTION OF THE DRAWINGS

The foregoing features, objects and advantages of the invention will become apparent to those skilled in the art from the following detailed description of the preferred embodiment, especially when considered in conjunction with the accompanying drawings in which like numerals in the several views refer to corresponding parts:

FIG. 1 is a perspective side view of a prior art timber jack;

FIG. 2 is a side view of a timber jack in accordance with a first embodiment of the invention;

FIG. 3 is a perspective view of a second embodiment of the invention;

FIG. 4 is a view showing the second embodiment positioned on a log in advance of elevation of the log; and

FIG. 5 is a view showing the log elevated from the ground and supported on the second embodiment of the invention.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

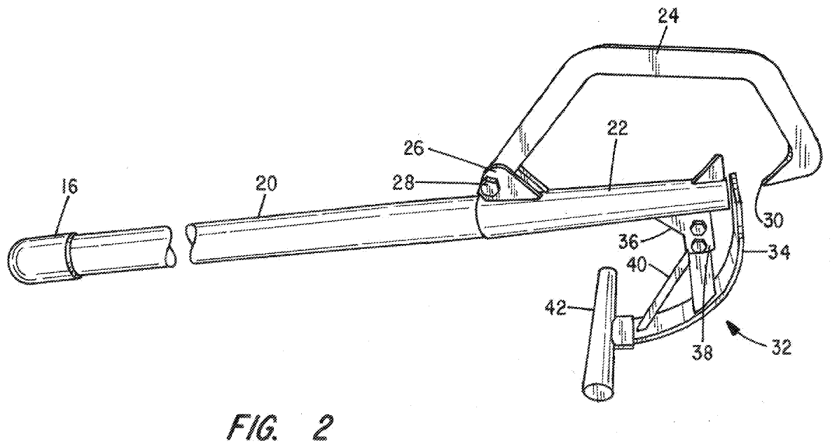

Referring to FIG. 2, in accordance with a first embodiment of the invention, it is seen to comprise an elongate pole 20 preferably of a hard wood, but alternatively a metal rod or pole. Affixed to a distal end portion of the pole 20 is a frustoconical collar member 22, also of a metal, such as steel. An arm 24 having a somewhat C-shaped contour is attached to the collar member 22 proximate a first end thereof by a clevis 26 which allows the arm to pivot about a bolt 28. The free end of the arm terminates in a sharp point 30 designed to penetrate into the bark of a log to be elevated from the ground. Also welded to the distal end of the collar 22 at a location aligned with the clevis 26 is a pointed barb 31.

Also secured to the distal end of the collar 22 is an arcuate fulcrum assembly indicated generally by numeral 32. It comprises a convexly rounded plate 34 that is suspended from an ear 36 welded to the underside of the collar 22 by a strap 38 bolted to the ear 36 at one end and that is welded at its other end to an inner surface of the convexly rounded plate 34. A brace 40 is welded at one end to the ear 36 and its opposite end is also welded to the inner surface of the rounded plate 34 at a location offset from the strap 38 connection to the rounded plate. Welded to a free end of the rounded plate is a foot member in the form of a transversely extending cylindrical rod 42.

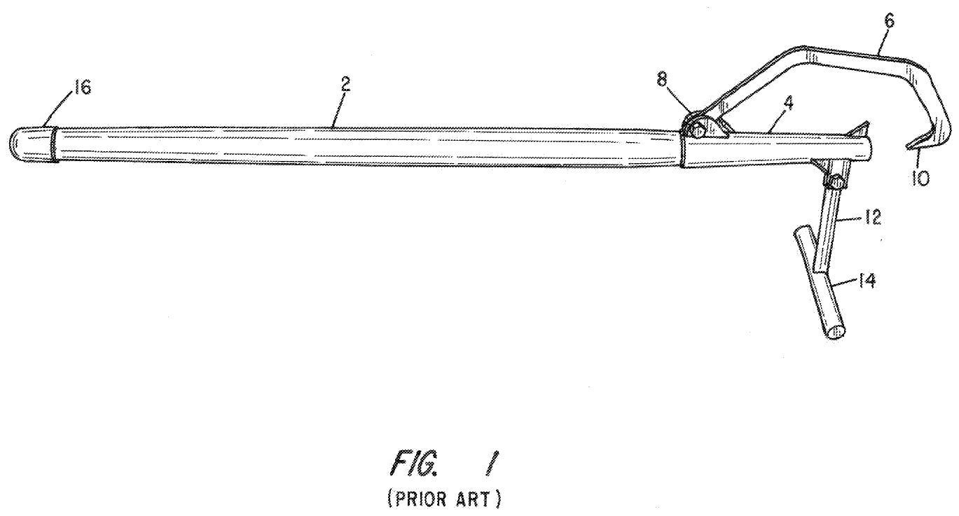

In use, the timber jack of FIG. 2 is placed against a log to be lifted with the handle 20 perpendicular to the ground and the arm 24 partially encircling the log to be elevated. Here, the arcuate fulcrum leading end abuts the ground. As the handle is now forced from the vertical start position toward a horizontal orientation, the barb 31 and the pointed end 30 on the end of the arm are made to penetrate into the log's bark, as the log is elevated by a rolling action of the arcuate fulcrum 32 so as to end up resting on the collar 22 and with the cylindrical rod foot member 42 and the proximal end of the handle 20 engaging the ground. Based on unscientific testing, it is estimated that the force required to roll logs onto the timber jack of FIG. 2 is about 75% less than that required to elevate the same log using the prior art timber jack of FIG. 1.

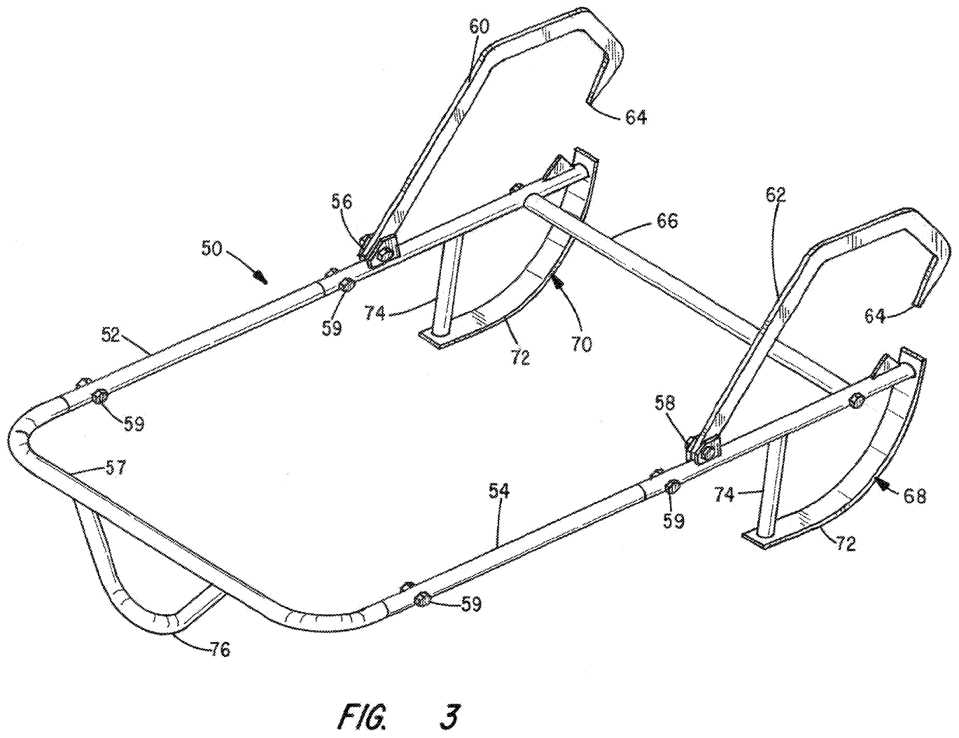

Turning next to FIG. 3, there is illustrated a second embodiment of the present invention. Here, the handle member is generally U-shaped having a pair of legs 52 and 54 joined by a cross member 57. The handle member may be formed as a single piece in a bending operation or, as shown, may be formed as three separate pieces that are designed to be fastened together and secured by bolts, as at 59, such that it thereby facilitates packaging and shipping when disassembled. The handle member 50 may comprise tubular or solid steel stock.

The legs 52 and 54 each have a clevis type connector 56, 58 welded to it a predetermined location for pivotally joining arm members 60, 62 to the handle member 50. As with the embodiment of FIG. 2, the arms 60 and 62 have a curved contour and with a pointed piercing member 64 at the free ends thereof. Again, in the view of FIG. 3, cooperating barbs 61 are welded to an upper surface of the legs 52, 54 on a distal end portion thereof.

A second cross member 66 is welded or otherwise fastened to the legs 52 and 54 close to the distal ends 68 and 70 of the legs such that they remain parallel to one another.

Arcuate fulcrum members 68 and 70 are affixed at the distal ends of the leg members 52 and 54. More particularly, each of the arcuate fulcrum members comprise a convex curved steel strip 72 welded at a first end to the free ends of the legs and to a tubular brace, as at 74, that is welded to and extends perpendicularly downward from each of the leg members 52, 54.

Completing the assembly is a somewhat V-shaped leveling member 76 that is joined to the cross member 57 and projects laterally therefrom for a distance corresponding to the length of the brace members 74 so that the U-shaped handle 50 will remain in a generally horizontal disposition when the arcuate fulcrum members 68, 70 and the leveling member 76 are resting on the ground.

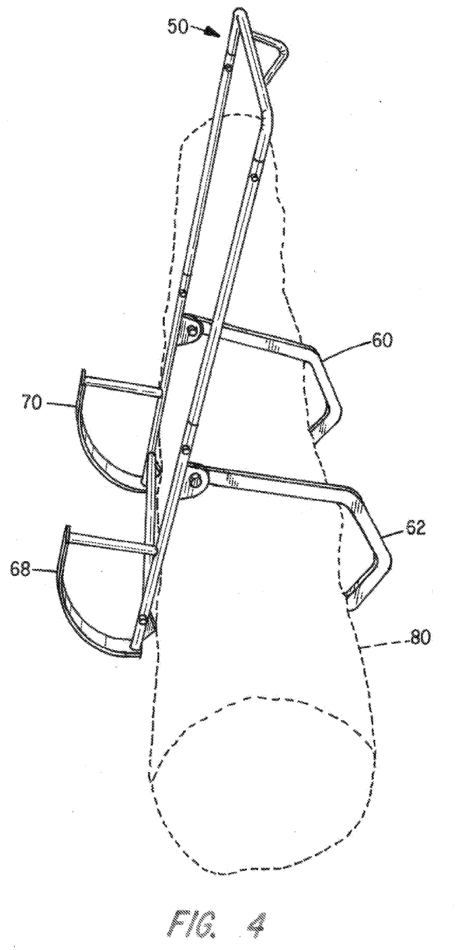

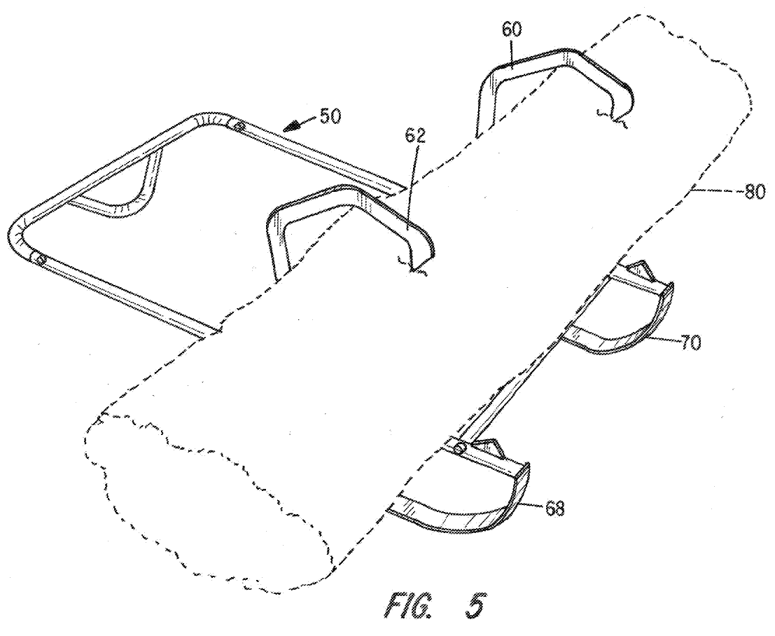

Referring next to FIGS. 4 and 5, the manner in which the embodiment of FIG. 3 is used will next be explained.

As seen in FIG. 4, the timber jack is positioned adjacent a side of a log 80 to be raised at an approximate midpoint of the log's length with the pointed barb 61 digging into the bark of the log on its near side, the U-shaped handle assembly 50 generally perpendicular to the ground and with the dual arms 60, 62 wrapped partially about the top and far side of the log 80. Now, by first pulling on the cross member 57 as a hand grip and then forcing the handle 50 down and thus rotating the handle counterclockwise when viewed in FIG. 4, the arcuate fulcrums 68 and 70 rotating will result in the log being securely lifted without slippage and brought to rest laying across the distal end portions of the legs 52, 54 when the leveling member 76 is made to rest on the ground, as seen in FIG. 5.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A timber jack for elevating cut logs from the ground comprising:
a) at least one elongate handle member having proximal and distal ends;
b) a curved arm having one end connected by a clevis at a position on the elongate handle a predetermined distance from said distal end, the curved arm terminating in a piercing member at a free end thereof; and
c) a continuously convexly curved arcuate fulcrum member extending between and rigidly affixed at the distal end of the elongate handle member and the end of a brace that extends perpendicularly from the elongate handle member.

2. (canceled)

3. The timber jack as in claim 1 wherein the clevis and the continuously convexly curved arcuate fulcrum member are connected to the elongate handle by a tubular sleeve fitted over a distal end portion of the elongate handle portion.

4. The timber jack as in claim 3 and further including a brace having a first end welded to the arcuate fulcrum proximate a midpoint thereof and joined to the tubular sleeve.

5. The timber jack as in claim 3 wherein the elongate handle member comprises a wooden cylindrical pole, one end portion of which is inserted into the tubular sleeve using a force fit tolerance.

6. The timber jack as in claim 1 wherein the elongate handle member is U-shaped, defining first and second legs connected together at their proximal ends by a cross element, and where each of said legs has the one of said curved arms connected by a clevis at a location a predetermined distance from distal ends thereof and one of said continuously convexly curved arcuate fulcrum members rigidly affixed at a distal end of each of said legs.

7. The timber jack as in claim 6 wherein the first and second legs are integrally joined to the cross element.

8. The timber jack as in claim 7 wherein the elongate handle member comprises one of solid metal rod and metal tubing.

9. The timber jack as in claim 6 and further including a second cross member extending between and joined to the first and second legs proximate the distal ends thereof.

10. The timber jack as in claim 6 and further including a leveling member joined to the cross element for maintaining the handle member generally parallel to the ground when the timber jack is made to elevate and support a log.

11. The timber jack as in claim 6 and further including pointed barbs affixed to distal end portions of each of the legs in linear alignment with a corresponding clevis.

12. A timber jack for elevating cut logs from the ground comprising:
a) at least one elongate handle member having proximal and distal ends;
b) a frustoconical collar member having a broader end and a narrower end, a clevis adjacent the broader end and a pointed barb adjacent the narrower end, said frustoconical collar member affixed to the distal end of the at least one elongate handle member;
c) a curved arm having one end connected to the clevis, the curved arm terminating in a piercing member at a free end thereof; and
d) a continuously convexly curved arcuate fulcrum member rigidly affixed to the frustoconical collar member by at least one brace extending from the frustoconical collar member.
